(19) United States
(12) Patent Application Publication
(10) Pub. No.: US 2014/0274131 A1
(43) Pub. Date: Sep. 18, 2014

(54) METHODS AND APPARATUS FOR ENHANCED NETWORK DEVICE LOCATION DETERMINATIONS

(71) Applicant: QUALCOMM INCORPORATED, (US)

(72) Inventor: Jian ZHANG, San Diego, CA (US)

(73) Assignee: QUALCOMM INCORPORATED, San Diego, CA (US)

(21) Appl. No.: 13/797,881

(22) Filed: Mar. 12, 2013

(51) Int. Cl. H04W 64/00; H04W 4/02

(52) U.S. Cl. CPC H04W 64/003; H04W 4/023
USPC 455/456.2; 455/561

(57) ABSTRACT

Methods and apparatus for location determination at a network device include determining whether a first time value exceeds a repositioning time threshold value and transmitting at least one instruction message to one or more mobile devices in response to determining that the first time value exceeds the repositioning time threshold value, wherein the at least one instruction message instructs the one or more mobile devices to report a mobile device location. Moreover, the methods and apparatus include receiving at least one mobile device location message from each of the one or more mobile devices as a result of the transmitting. Also, the method and apparatus include computing a network device location estimate based at least in part on the at least one mobile device location message.

### BACKGROUND

Aspects of the present disclosure relate generally to wireless communication systems, and more particularly to enhanced network device location determinations.

Wireless communication systems are widely deployed to provide various types of communication content such as voice, data, and so on. These systems may be multiple-access systems capable of supporting communication with multiple users by sharing the available system resources (e.g., bandwidth and transmit power). Examples of such multiple-access systems include code division multiple access (CDMA) systems, time division multiple access (TDMA) systems, frequency division multiple access (FDMA) systems, 3GPP Long Term Evolution (LTE) systems, and orthogonal frequency division multiple access (OFDMA) systems.

Generally, a wireless multiple-access communication system can simultaneously support communication for multiple wireless terminals. Each terminal communicates with one or more base stations via transmissions on the forward and reverse links. The forward link (or downlink) refers to the communication link from the base stations to the terminals, and the reverse link (or uplink) refers to the communication link from the terminals to the base stations. This communication link may be established via a single-in-single-out, multiple-in-signal-out or a multiple-in-multiple-out (MIMO) system.

To supplement conventional mobile phone network base stations, additional base stations may be deployed to provide more robust wireless coverage to mobile units. For example, wireless relay stations and small-coverage base stations (e.g., commonly referred to as access point base stations, Home NodeBs, femto access points, or femto cells) may be deployed for incremental capacity growth, richer user experience, and in-building coverage. Typically, such small-coverage base stations are connected to the Internet and the mobile operator's network via DSL router or cable modem. As these other types of base stations may be added to the conventional mobile phone network (e.g., the backhaul) in a different manner than conventional base stations (e.g., macro base stations), there is a need for effective techniques for managing these other types of base stations and their associated user equipment.

In some wireless communication systems, femto cells are deployed to improve wireless network communications when experiencing poor base station (e.g., Home Node B) connections. Such deployments typically occur indoors to help alleviate poor signal strength by facilitating mobile communication with the network via broadband. Similar to larger base stations, femto cells require periodic location determination to enable such communication with the network. However, as femto cells are often deployed indoors, femto cells may be unable to obtain their locations due to weakened self-localization equipment signals. Thus, enhancements in femto cell location determinations are desired.

### SUMMARY

In one aspect, a method for location determination at a network device includes determining whether a first time value exceeds a repositioning time threshold value. The method further includes transmitting at least one instruction message to one or more mobile devices in response to determining that the first time value exceeds the repositioning time threshold value, wherein the at least one instruction message instructs the one or more mobile devices to report a mobile device location. Moreover, the method includes receiving at least one mobile device location message from each of the one or more mobile devices as a result of the transmitting and computing a network device location estimate based at least in part on the at least one mobile device location message.

Another aspect of the disclosure provides an apparatus for location determination at a network device including means for determining whether a first time value exceeds a repositioning time threshold value. The apparatus further includes means for transmitting at least one instruction message to one or more mobile devices in response to determining that the first time value exceeds the repositioning time threshold value, wherein the at least one instruction message instructs the one or more mobile devices to report a mobile device location. Moreover, the apparatus includes receiving at least one mobile device location message from each of the one or more mobile devices as a result of the transmitting and computing a network device location estimate based at least in part on the at least one mobile device location message.

In another aspect, a computer program product for location determination at a network device comprising a computer-readable medium includes instructions executable by a computer. For example, the computer-readable medium includes at least one instruction for determining whether a first time value exceeds a repositioning time threshold value. The computer-readable medium further includes at least one instruction for transmitting at least one instruction message to one or more mobile devices in response to determining that the first time value exceeds the repositioning time threshold value, wherein the at least one instruction message instructs the one or more mobile devices to report a mobile device location. Moreover, the computer-readable medium includes at least one instruction for receiving at least one mobile device location message from each of the one or more mobile devices as a result of the transmitting and at least one instruction for computing a network device location estimate based at least in part on the at least one mobile device location message.

Additional aspects provide a network device apparatus for location determination including a location determination component configured to determine whether a first time value exceeds a repositioning time threshold value. Further, the apparatus includes a communication component configured to transmit at least one instruction message to one or more mobile devices in response to determining that the first time value exceeds the repositioning time threshold value, wherein the at least one instruction message instructs the one or more mobile devices to report a mobile device location. Moreover, the communication component is configured to receive at least one mobile device location message from each of the one or more mobile devices as a result of the transmitting and the location determination component is configured to compute a network device location estimate based at least in part on the at least one mobile device location message.

These and other aspects will become more fully understood upon a review of the detailed description, which follows.

### BRIEF DESCRIPTION OF THE DRAWINGS

The features, nature, and advantages of the present disclosure will become more apparent from the detailed description set forth below when taken in conjunction with the drawings in which like reference characters identify correspondingly throughout and wherein:

FIG. 1 is a schematic diagram of a communication network including an aspect of a network device that may perform location determinations;

FIG. 2 is a schematic diagram of an aspect of the location determination component of FIG. 1;

FIG. 3 is a schematic diagram of an aspect of the network device location estimation component of FIG. 2;

FIG. 4 is a flowchart of an aspect of a method of location determination at a network device, e.g., according to FIG. 1;

FIG. 5 is a flowchart of another aspect of a method of location determination at a network device, e.g., according to FIG. 1;

FIG. 6 is a flowchart of a further aspect of the location estimation algorithm of FIG. 5 at a network device, e.g., according to FIG. 1;

FIG. 7 illustrates a multiple access wireless communication system including an aspect of the network device described herein;

FIG. 8 illustrates a block diagram of a communication system including an aspect of the network device described herein;

FIG. 9 illustrates a wireless communication system, configured to support a number of users, in which the aspects related to the network device described herein may be implemented;

FIG. 10 illustrates an exemplary communication system to enable deployment of femto nodes within a network environment including an aspect of the network device described herein;

FIG. 11 illustrates an example of a coverage map where several tracking areas are defined, some of which may be provided by the network device described herein.

### DESCRIPTION

The techniques described herein may be used for various wireless communication networks such as Code Division Multiple Access (CDMA) networks, Time Division Multiple Access (TDMA) networks, Frequency Division Multiple Access (FDMA) networks, Orthogonal FDMA (OFDMA) networks, Single-Carrier FDMA (SC-FDMA) networks, etc. The terms “networks” and “systems” are often used interchangeably. A CDMA network may implement a radio technology such as Universal Terrestrial Radio Access (UTRA), cdma2000, etc. UTRA includes Wideband-CDMA (W-CDMA) and Low Chip Rate (LCR). It is noted that cdma2000 covers IS-2000, IS-95 and IS-856 standards. A TDMA network may implement a radio technology such as Global System for Mobile Communications (GSM). An OFDMA network may implement a radio technology such as Evolved UTRA (E-UTRA), IEEE 802.11, IEEE 802.16, IEEE 802.20, Flash-OFDM®, etc. UTRA, E-UTRA, and GSM are part of Universal Mobile Telecommunication System (UMTS). Long Term Evolution (LTE) is an upcoming release of UMTS that uses E-UTRA. UTRA, E-UTRA, GSM, UMTS and LTE are described in documents from an organization named “3rd Generation Partnership Project” (3GPP). It is noted that cdma2000 is described in documents from an organization named “3rd Generation Partnership Project 2” (3GPP2). These various radio technologies and standards are known in the art. For clarity, certain aspects of the techniques are described below for LTE, and LTE terminology is used in much of the description below.

Single carrier frequency division multiple access (SC-FDMA), which utilizes single carrier modulation and frequency domain equalization is a technique. SC-FDMA has similar performance and essentially the same overall complexity as those of OFDMA system. SC-FDMA signal has lower peak-to-average power ratio (PAPR) because of its inherent single carrier structure. SC-FDMA has drawn great attention, especially in the uplink communications where lower PAPR greatly benefits the mobile terminal in terms of transmit power efficiency. It is currently a working assumption for uplink multiple access scheme in 3GPP Long Term Evolution (LTE), or Evolved UTRA.

In some aspects the teachings herein may be employed in a network that includes macro scale coverage (e.g., a large area cellular network such as a 3G networks, typically referred to as a macro cell network) and smaller scale coverage (e.g., a residence-based or building-based network environment). As an access terminal (“AT”) moves through such a network, the access terminal may be served in certain locations by access nodes (“ANs”) that provide macro coverage while the access terminal may be served at other locations by access nodes that provide smaller scale coverage. In some aspects, the smaller coverage nodes may be used to provide incremental capacity growth, in-building coverage, and different services (e.g., for a more robust user experience). In the discussion herein, a node that provides coverage over a relatively large area may be referred to as a macro node. A node that provides coverage over a relatively small area (e.g., a residence) may be referred to as a femto node. A node that provides coverage over an area that is smaller than a macro area and larger than a femto area may be referred to as a pico node (e.g., providing coverage within a commercial building).

A cell associated with a macro node, a femto node, or a pico node may be referred to as a macro cell, a femto cell, or a pico cell, respectively. In some implementations, each cell may be further associated with (e.g., divided into) one or more sectors.

In various applications, other terminology may be used to reference a macro node, a femto node, or a pico node. For example, a macro node may be configured or referred to as an access node, base station, access point, eNodeB, macro cell, and so on. Also, a femto node may be configured or referred to as a Home NodeB, Home eNodeB, access point base station, femto cell, femto access point, and so on.

The present aspects generally relate to enhanced network device location determinations. In particular, issues arise at network devices attempting to obtain location information from or in areas having restricted self-localization equipment signals. Typical self-location equipment may include GPS modules. For example, network devices such as femto cells are required to obtain periodic location information for network communication purposes. The inability to obtain such information may lead to network communication failures. Further, femto cells deployed in communication restrictive areas may be unable to receive location information (e.g., GPS information). On the other hand, the one or more UEs communicating with a given femto cell may be able to obtain location information. Network devices such as femto cells may obtain location information from the one or more UEs, and therefore estimate their location from the gathered location information. Accordingly, in some aspects, the present methods and apparatuses may provide an efficient solution, as compared to current solutions, to determine network device location information.

Referring to FIG. 1, in one aspect, a wireless communication system 10 includes a network device 12 configured to perform location determination. Network device 12 may provide communication coverage for one or more UEs 14. As such, network device 12 may transit and/or receive communications 24 with the one or more UEs 14. In some aspects, communications 24 may include, but not be limited to, position and/or time information. Further, the network device 12 may be in communication coverage 22 of at least one orbital object 18 providing location information. For example, orbital object 18 may be one or more global positioning system (GPS) satellites providing positioning and/or time information to various electronics capable of receiving such information via GPS transceivers, such as UEs 14 via communications 20 and base station 16 via communication channel 28. Furthermore, one or more UEs 14 may be in communication coverage 26 with one or more base stations including base station 16, which in turn is connected to one or more networks, such as network 38. Additionally, it should be understood that network device 12 and/or base station 16 may be a macrocell, picocell, femtocell, relay, Node B, mobile Node B, UE (e.g., communicating in peer-to-peer or ad-hoc mode with UEs 14), or substantially any type of component that can communicate with UEs 14 and/or orbital object 18. Further, it should be understood that the phrase “mobile device(s)” may be used interchangeably with, and hence carry the same meaning as UE (e.g., UEs 14).

In some aspects, network device 12 may be deployed indoors or in areas with poor wireless coverage of base station 16. In other words, as a result of the weak signal strength experienced in some areas (e.g., indoors), network device 12 may be deployed to assist in provided communication service (e.g., communications 24) to one or more UEs 14. Network device 12 may maintain an active connection to the same or different network provider of service as base station 16 (e.g., network 38). In some aspects, a network provider (e.g., network 38) may require network devices (e.g., network device 12) to report location information at any given time. For example, network 38 may instruct network device 12 to report location information at a requested time (e.g., immediate and/or periodic). Network device 12 may then obtain location information via communication 22 with orbital object 18. However, in some cases, network device 12 communication 22 with orbital object 18 may be hampered by poor signal strength as a result of the network device's 12 deployment in signal obstructing areas (e.g., indoors). In order to overcome the aforementioned disadvantages, network device 12 may utilize its communication 24 with UEs 14 to obtain or otherwise estimate its location information.

According to the present aspects, network device 12 may include a location determination component 26 configured to determine network device 12 location information from at least one or more of the orbital object 18 and/or UEs 14. For example, where network device 12 cannot obtain and/or receive its location information from orbital object 18, location determination component 26 may obtain or otherwise receive location information (e.g., included in communication 24) from one or more UEs 14, and subsequently determine an estimated network device 12 location (e.g., network device location estimate 52, FIG. 2) based at least on the received information.

Further, network device 12 may include an orbital object component 32 configured to obtain or otherwise receive communication 22 from an orbital object 18. For example, location determination component 26 may obtain or otherwise receive, via the orbital object component 32, location information (e.g., communication 22) from one or more orbital objects 18. In some cases, orbital object component 32 may be a GPS transceiver configured to obtain and/or receive network device 12 location information at a particular time.

In addition, network device 12 may include a communication component 34, which may be configured to transmit and receive communications 24 with one or more UEs 14. For example, in an aspect, the communication component 34 may receive location and/or time information from one or more UEs 14. Further, communication component 34 may include, but is not limited to, one or more of a transmitter, a receiver, a transceiver, protocol stacks, transmit chain components, and receive chain components.

Referring to FIG. 2, in an aspect, location determination component 30 includes various components which may be configured to at least determine network device location based on information received from one or more devices in communication with thereof. For example, location determination component 30 may determine the location of network device 12 based on communications 24 received from one or more UEs 14. Such location determination may be triggered via the network 38, programmed, or operator configured. The location determination component 30 may include an instruction message generator 40 configured to generate at least one instruction message 42 instructing one or more UEs 14 to report a UE device location. For example, the communication component 34 may receive from the instruction message generator 40 of the location determination component 30 an instruction message 42 to be transmitted to one or more UEs 14.

In an aspect, the location determination component 30 may include network device location estimation component 44, which may be configured to estimate the location of network device 12 based on received communication 24 from UEs 14. For example, the network device location estimation component 44 may receive or otherwise obtain (e.g., via communication component 34) at least one mobile device location message 46 from each of the one or more mobile devices (e.g., UEs 14) as a result of the transmitting. The mobile device location message 46 may include information corresponding to one or more mobile devices. For example, the mobile device location message 46 may include one or more of a mobile device location, a mobile ID, a timestamp, a GPS signal signal-to-noise ratio, GPS availability, and a signal-to-noise of a Bluetooth or WiFi signal. The foregoing mobile related information may be stored in the network device location estimation component. The network device location estimation component 44 may then provide or otherwise forward the mobile device location message 46 to the location estimation computing component 48 for location estimation computing purposes. In particular, the location estimation computing component 48 may compute a network device location estimate 52 based at least in part on the at least on mobile device location message 46. Further aspects regarding the location estimation computing component 48 are described herein with respect to FIG. 3.

The network device location estimation component 44 may store a located time value 50, which is a time at which the network device location estimate 52 is computed. For example, the located time value may provide indication to the network 38 as to the precise time the estimated location of the network device 12 was computed. Further, the located time value 50 may be forwarded or transmitted upon request to the time comparator 58. The time comparator 58 may trigger the instruction message generator 40 to generate an instruction message 42 based on the resulting comparison at time comparator 58. For example, time comparator 58 may receive the located time value 50 for comparison to a repositioning time threshold value 60. For instance, in an aspect, repositioning time threshold value 60 may be a value of a time period, e.g., minutes, days, weeks, etc., obtained from an operator of system 10 or otherwise programmed into network device 12. Further, the actual value of repositioning time threshold value 60 may be variable and configurable, for example, based on an estimate of what constitutes an amount of time that represents a fresh or valid location, or conversely a stale location, of network device 12, and as such may vary from one network device to another, for example, depending on operating conditions or network setup. Repositioning time threshold value 60 may be a maximum time duration in which the network device location estimate 52 can be considered valid. However, prior to comparison, the time comparator 58 computes or otherwise determines the difference of the located time value 50 and a second time value 66, wherein the second time value 66 may be the current time at which the comparison is to occur. In other words, the second time value 66 may be the time at which the location determination component 30 is triggered, or triggers the various components thereof, to determine the location of network device 12. In other non-limiting cases, time comparator 58 may continually or periodically determine the difference between located time value 50 and the current time (e.g., second time value 66) for subsequent comparison with repositioning time threshold value 60. If the time comparator 58 determines that the time difference between the located time value 50 and the second time value 66 is equal to or greater than the repositioning time threshold value 60, then time comparator 58 may transmit an instruction message trigger 68 to the instruction message generator 40 to generator an instruction message 42. However, if the time comparator 58 determines that the time difference between the located time value 50 and the second time value 66 is less than the repositioning time threshold value 60, then time comparator may determine the location is currently valid.

In a further aspect of time comparator 58, a first time value 64 may be obtained and/or utilized to determine whether the first time value 64 exceeds a repositioning time threshold value 60. For example, first time value 64 may be the time at which a prior network device location estimate was determined. In other words, the network device location estimate 52 may have been determined at the located time value 50 as a result of an invalid first time value 64 (e.g., first time value 64>repositioning time threshold value 60), wherein the time comparator 58 computed the difference of the first time value 64 and a time prior to the initiation of the network device location estimation, and compared the difference to the repositioning time threshold value 60. In some cases, time comparator 58 may automatically send an instruction message trigger 68 to the instruction message generator 40 upon power initiation (e.g., network device 12 power up) of network device 12. In other cases, time comparator 58 may also include a network device location estimation time threshold value, which may limit the operating duration of the network device location estimation component 44.

Additional aspects of the location determination component 30 may include an orbital object monitoring component 54, which may be configured to determine whether the network device 12 can, e.g., is able to, receive communications 22 from orbital object 18. For example, orbital object monitoring component 54 may be configured to determine whether the network device 12 can receive a GPS signal. If the orbital object monitoring component 54 determines that a GPS signal can be received (e.g., sufficient orbital object 18 signal strength at network device 12), then orbital object monitoring component 54 instructs or otherwise provides a response to the orbital object component 32 to receive and/or obtain network device 12 location information (via communications 22). However, if orbital object monitoring component 54 determines that network device 12 cannot receive a GPS signal (e.g., insufficient/weak orbital object 18 signal strength at network device 12), then orbital object monitoring component 54 may transmit an instruction message trigger 56 to the instruction message generator 40 to generate an instruction message 42 and thus commence network device 12 location estimation.

Referring to FIG. 3, in an aspect, location estimation computing component 48 includes various components that may be configured to compute a location estimation of the network device 12. For example, network device location estimation component 44 may provide or otherwise forward the mobile device location message 46 to the location estimation computing component 48 for location estimation computing purposes. Location estimation computing component 48 may compute a network device location estimate 52 based at least in part on the at least on mobile device location message 46.

In an aspect, location estimation computing component 48 may include mobile device signal strength determiner 70, which may be configured to determine a group of strongest mobile devices based on one or more signal-to-noise ratios. In some non-limiting cases, the signal-to-noise ratios may be of Bluetooth and/or WiFi signals. Further, mobile device signal strength determiner 70 may assign a new network device location estimate value 72 based on the mobile device location of a mobile device (e.g., any one of UEs 14) from the group of strongest mobile devices that has a lowest signal-to-noise ratio for a signal from orbital object 18 (e.g., GPS), such as for those mobile devices where the signal from orbital object 18 is available.

Further aspects of location estimation computing component 48 may include network location estimate determiner 74, which may be configured to, among other aspects, set the network device location estimate 52 to either the new network device location estimate value 72 or an old network device location estimate value 76. For example, network location device estimate determiner 74 may determine whether an old network device location estimate value 76 exists, and if an old network device location estimate value 76 does not exist, then network location device estimate determiner 70 may set or otherwise indicate the network device location estimate 52 to the new network device location estimate value 72.

In aspects where the network location device estimate determiner 74 determines that an old network device location estimate value 76 exists, the network location device estimate determiner 74 may initiate comparator 78 to compare the network device location estimate values. For example, the comparator 78 may compare the old network device location estimate value 76 to the new network device location estimate value 72 to obtain a location difference value 80. The location difference value may indicate the difference in distance according to some unit of measurement (e.g., distance metric). Comparator 78 may also comparer the location difference value 80 to a location difference threshold value 82. The location difference threshold value 82 may represent a maximum acceptable difference in distance between the old and new network device location estimations. Further, the location difference threshold value may be pre-stored, user configurable, or network provided and/or configurable. Comparator 78 may subsequently provide the result of the comparison to the network location device estimate determiner 74, which may then set the network device location estimate 52 to the new network device location estimate value 72 where the location difference value 80 is equal to or greater than the location difference threshold value 82.

Additional aspects of the location estimation computing component 48 may include midpoint computation component 84, which may be configured to determine or otherwise compute a midpoint between two or more network device location estimations based on certain conditions. As used herein, “midpoint” may refer to any value in between two or more network device location estimations, or to an average, mean, median, or other function of such values. Such conditions may include, but not be limited to, an indication from the comparator 78 that location difference value 80 is less than the location difference threshold value 82. For example, in some cases, comparator 78 may indicate that location difference value 80 is less than the location difference threshold value 82. In such cases, midpoint computation component 84 may compute a midpoint between the old network device location estimate value 76 and the new network device location estimate value 72 to determine a midpoint network device location estimate value 86. For example, in an aspect, the midpoint between the old network device location estimate value 76 and the new network device location estimate value 72 may be the mean or median of the two estimation values. In other aspects, midpoint computation component 84 may configure a midpoint algorithm to assign weights to each network device location estimate value. For example, midpoint computation component may weigh either old network device location estimate value 76 or new network device location estimate value more heavily in the computation of the midpoint network device location estimate value 86. Midpoint computation component 84 may directly set or otherwise forward the midpoint network device location estimate value 86 to the location estimation computing component 48 to set as the network device location estimate 52.

Referring to FIG. 4, in operation, a network device such as network device 12 (FIG. 1) may perform one aspect of a method 90, for performing location determinations. While, for purposes of simplicity of explanation, the method is shown and described as a series of acts, it is to be understood and appreciated that the method is not limited by the order of acts, as some acts may, in accordance with one or more embodiments, occur in different orders and/or concurrently with other acts from that shown and described herein. For example, it is to be appreciated that a method could alternatively be represented as a series of interrelated states or events, such as in a state diagram. Moreover, not all illustrated acts may be required to implement a method in accordance with one or more features described herein.

In an aspect, at block 91, the method 90 includes determining whether a first time value exceeds a repositioning time threshold value. For example, as described herein, location determination component 30 (FIG. 2) may execute time comparator 58 to determine whether the first time value 64 exceeds a repositioning time threshold value. Further, the determination may include comparing the first time value 64 to a repositioning time threshold value 60 and determining whether the network device 12 can receive the orbital object 18 signal where the first time value 64 is greater than the repositioning time threshold value 60. That is, time comparator 58 may provide indication to the orbital object monitoring component 54 to determine whether the network device 12 can receive or otherwise obtain the orbital object 18 signal when the first time value 64 exceeds the repositioning time threshold value 60. If the first time value 64 is determined to be valid (e.g., time difference<repositioning time threshold value 60), then method 90 may restart at a subsequent time to consider the validity of the first time value 64 (e.g., periodic validity checking). If the first time value 64 is considered invalid (e.g., time difference>repositioning time threshold value 60), then method 90 proceeds to optional block 92 or to block 93.

At block 92, the method 90 optionally includes determining whether the network device can receive can receive an orbital object signal. For instance, in the aforementioned disclosure, location determination component 30 may execute orbital object monitoring component 54 (FIG. 2) to determine whether the network device 12 can receive or otherwise obtain an orbital object 18 signal. Orbital object monitoring component 54 may send an instruction message trigger 56 triggering at least the instruction message 42 transmission if orbital object component 32 is unable to receive orbital object 18 signals.

Further, at block 93, the method 90 includes transmitting one or more instruction messages to one or more UEs 14 in response to determining that the first time value exceeds the repositioning time threshold value. For example, as described herein, location determination component 30 may execute instruction message generator 40 (FIG. 2) to generate instruction message 42 and provide instruction message to the communication component 34 for transmission to one or more mobile devices (UEs 14). In some aspects, the instruction message 42 instructs one or more mobile devices to report a mobile device location.

At block 94, the method 90 includes receiving one or more mobile device location messages. For instance, as described herein, location determination component 30 may execute network device location estimation component 44 (FIG. 2) to receive at least one mobile device location message 46 from each of the one or more mobile devices (e.g., UEs 14) as a result of the transmitting.

Moreover, at block 95, the method 90 includes computing a network device location estimate. For example, as described herein, location determination component 30 and/or the network device location estimation component 44 may execute the location estimation computing component 48 (FIGS. 2 and 3) to compute a network device location estimate based at least in part on the at least one mobile device location message 46.

At block 96, method 90 may optionally include storing a located time value. For instance, as described herein, location determination component 30 may execute network device location estimation component 44 (FIG. 2) to store a located time value 50.

Additionally, at block 97, the method 90 may optionally determine whether a time difference is greater than a difference threshold. For example, as described herein, location determination component 30 may execute time comparator 58 (FIG. 2) to determine whether a time difference between the second time value 66 and the location time value 50 is greater than a repositioning time threshold value 60. If the time difference is determined to be greater than repositioning time threshold value 60, then method 90 proceeds to optional block 92 or block 93. However, if the time difference is less than the repositioning time threshold value 60, method 90 may continue the comparing block 97 until expiration of a location determination timer.

Referring to FIG. 5, in operation, a femto cell, which may be the same as or similar to network device 12 (FIG. 1) may perform one aspect of a method 130, for performing location determinations. While, for purposes of simplicity of explanation, the method is shown and described as a series of acts, it is to be understood and appreciated that the method is not limited by the order of acts, as some acts may, in accordance with one or more embodiments, occur in different orders and/or concurrently with other acts from that shown and described herein. For example, it is to be appreciated that a method could alternatively be represented as a series of interrelated states or events, such as in a state diagram. Moreover, not all illustrated acts may be required to implement a method in accordance with one or more features described herein.

In an aspect, at block 132, method 130 includes determining whether the current time difference with the timestamp of the position (FP) is larger than a threshold value T1. For example, the location determination component 30 may execute the time comparator 58 (FIG. 2) to determine whether the current time difference (e.g., difference of located time value 50 and second time value 66) is larger than a threshold value (e.g., repositioning time threshold value 60). If the time difference is less than the threshold value, block 132 may continue to periodically monitor and compare the time difference with the threshold. If the time difference is determined to be greater than the threshold value, method 130 proceeds to block 134 where femto cell enables the GPS. For example, network device 12 may enable orbital object component 32 (FIG. 1) and subsequently instruct location determination component 30 to execute orbital object monitoring component 54 (FIG. 2) to determine whether orbital object component 32 (e.g., GPS) can receive GPS signals at block 136. If the femto cell can receive GPS signals, method 130 proceeds to block 138, where femto cell obtains position information and disables GPS. For example, location determination component 30 may receive location information from the orbital object component 32 (FIG. 2) representing the location of the femto cell (e.g., network device 12). If GPS signals cannot be received (e.g., due to weak signal strength), method 160 may proceed to block 140 where femto cell disables GPS and initiates the location estimation algorithm. For example, location determination component 30 may execute network device location estimation component 44 (FIG. 2) to initiate location estimation of the femto cell (e.g., network device 12). Further aspects regarding the location estimation algorithm are described herein with respect to FIG. 6. Method 130 may further include, at block 142, obtaining a new position of the femto cell. For example, the location determination component 30 may execute the network device location estimation component 44 (FIG. 2) to obtain a new location of the femto cell (e.g., network device 12). If a new femto cell location is successfully obtained, method 130 may proceed to block 144, where femto cell stores the new location information and the corresponding time related to the obtained femto cell location. For instance, the location determination component 30 may execute network device location estimation component 44 to store the new location information (e.g., network device location estimate 52) and timestamp (e.g., located time value 50). Further, method 130 may determine whether the location estimation algorithm has run for predetermined time period T2. In other words, the femto cell determines whether the algorithm timer has met or exceeded the threshold T2. For example, the location determination component 30 may execute any one or more subcomponents (e.g., time comparator 58) to determine whether the algorithm timer has met or exceeded the algorithm timer threshold value. If the algorithm timer has met or exceeded the algorithm timer threshold value, method 130 returns to block 132. However, if the algorithm timer has not met or exceeded the algorithm timer threshold value, then method 130 returns to block 140.

Referring to FIG. 6, in operation, a network device such as network device 12 (FIG. 1) may perform a further aspect of the location estimation method 150 according to the location estimation algorithm (Block 140, FIG. 5). In an aspect, method 150 includes, at block 152, the femto cell identifying mobile devices within the femto cell coverage area and sends instructions to mobile devices to report location information. For example, the location determination component 30 may execute instruction message generator 40 (FIG. 2) to send one or more instruction messages 42 to one or more mobile devices (e.g., UEs 14). Further, at block 154, method 150 may include mobile devices receiving instructions and obtaining GPS location info. At block 156, method 150 may include femto cell receiving and storing one or more mobile device GPS location information as MP_{—}1. For instance, location determination component 30 may execute network device location estimation component 44 to receive and store one or more mobile device GPS location information (e.g., mobile device location message 46). At block 158, method 150 may include femto cell (e.g., network device 12) determining its new estimated location FP_new based on MP_{—}1. For example, location determination component 30 may execute network device location estimation component 44 (FIG. 2) to determine its new location information (e.g., network device location estimate 52). At block 160, method 150 may determine whether FP_new is the first determined position. For example, location determination component 30 and/or network device location estimation component 44 may execute location estimation computing component 48 (FIG. 3) to compare whether FP_new is the first determined position (e.g., determining whether old network device location estimate value 76 exists). If FP_new is the first determined position, method 150 proceeds to block 162 and femto cell designates the FP value as the FP_new to indicate an updated FP. For instance, location estimation computing component 48 (FIG. 3) may execute network location device estimate determiner 74 to designate the network device location estimate 52 as the new network device location estimate value 72. However, if FP_new is not the first determined position (e.g., a prior/old network device location estimate value exists), then method 150 may proceed to block 164 where the femto cell determines whether the distance between FP_new and FP_old is larger than a threshold L1. For example, location estimation computing component 48 may execute network location device estimate determiner 74 (FIG. 3) to determine whether the distance between FP_new and FP_old is larger than a threshold L1. If the difference in distance greater than the threshold L1, then method 150 proceeds to block 162 where FP_new is designated as the FP. However, if the difference in distance between FP_new and FP_old is less than the threshold L1, then method 150 proceeds to block 166, where femto cell computes the midpoint of FP_new and FP_old as its estimated location. For example, location estimation computing component 48 may execute midpoint computation component 84 to determine the midpoint of FP_new and FP_old. Method 150 then proceeds to block 142 of FIG. 5.

Referring to FIG. 7, a multiple access wireless communication system according to one aspect is illustrated. An access point 100 (AP) includes multiple antenna groups, one including 104 and 106, another including 108 and 110, and an additional including 112 and 114. Further, in some aspects, AP 100 may be the same or similar as base station 16 and/or network device 12 including at least the location determination component 30 (FIG. 1). In FIG. 7, only two antennas are shown for each antenna group, however, more or fewer antennas may be utilized for each antenna group. Access terminal 116 (AT) is in communication with antennas 112 and 114, where antennas 112 and 114 transmit information to access terminal 116 over forward link 120 and receive information from access terminal 116 over reverse link 118. Access terminal 122 is in communication with antennas 106 and 108, where antennas 106 and 108 transmit information to access terminal 122 over forward link 126 and receive information from access terminal 122 over reverse link 124. In some aspects, ATs 116 and 122 may be the same as or similar to UEs 14 (FIG. 1). In a FDD system, communication links 118, 120, 124 and 126 may use different frequency for communication. For example, forward link 120 may use a different frequency then that used by reverse link 118.

Each group of antennas and/or the area in which they are designed to communicate is often referred to as a sector of the access point. In the aspect, antenna groups each are designed to communicate to access terminals in a sector of the areas covered by access point 100.

In communication over forward links 120 and 126, the transmitting antennas of access point 100 utilize beamforming in order to improve the signal-to-noise ratio of forward links for the different access terminals 116 and 124. Also, an access point using beamforming to transmit to access terminals scattered randomly through its coverage causes less interference to access terminals in neighboring cells than an access point transmitting through a single antenna to all its access terminals.

An access point may be a fixed station used for communicating with the terminals and also may be referred to as an access point, a Node B, an evolved Node B (eNB), or some other terminology. An access terminal may also be called an access terminal, user equipment (UE), a wireless communication device, terminal, access terminal or some other terminology.

FIG. 8 is a block diagram of an aspect of a transmitter system 210 (also known as the access point) and a receiver system 250 (also known as access terminal) in a Multiple-Input Multiple-Output (MIMO) system 200. In other aspects, transmitter system 210 may be the same as or similar to network device 12 and/or base station 16 (FIG. 1). Further, in other aspects, receiver system 250 may be the same as or similar to UEs 14 (FIG. 1). At the transmitter system 210, traffic data for a number of data streams is provided from a data source 212 to a transmit (TX) data processor 214.

In an embodiment, each data stream is transmitted over a respective transmit antenna. TX data processor 214 formats, codes, and interleaves the traffic data for each data stream based on a particular coding scheme selected for that data stream to provide coded data.

The coded data for each data stream may be multiplexed with pilot data using OFDM techniques. The pilot data is typically a known data pattern that is processed in a known manner and may be used at the receiver system to estimate the channel response. The multiplexed pilot and coded data for each data stream is then modulated (i.e., symbol mapped) based on a particular modulation scheme (e.g., BPSK, QSPK, M-PSK, or M-QAM) selected for that data stream to provide modulation symbols. The data rate, coding, and modulation for each data stream may be determined by instructions performed by processor 230.

The modulation symbols for all data streams are then provided to a TX MIMO processor 220, which may further process the modulation symbols (e.g., for OFDM). TX MIMO processor 220 then provides N_{T} modulation symbol streams to N_{T} transmitters (TMTR) 222a through 222t. In certain embodiments, TX MIMO processor 220 applies beamforming weights to the symbols of the data streams and to the antenna from which the symbol is being transmitted.

Each transmitter 222 receives and processes a respective symbol stream to provide one or more analog signals, and further conditions (e.g., amplifies, filters, and upconverts) the analog signals to provide a modulated signal suitable for transmission over the MIMO channel. N_{T} modulated signals from transmitters 222a through 222t are then transmitted from N_{T} antennas 224a through 224t, respectively.

At receiver system 250, the transmitted modulated signals are received by N_{R} antennas 252a through 252r and the received signal from each antenna 252 is provided to a respective receiver (RCVR) 254a through 254r. Each receiver 254 conditions (e.g., filters, amplifies, and downconverts) a respective received signal, digitizes the conditioned signal to provide samples, and further processes the samples to provide a corresponding “received” symbol stream.

An RX data processor 260 then receives and processes the N_{R} received symbol streams from N_{R} receivers 254 based on a particular receiver processing technique to provide N_{T} “detected” symbol streams. The RX data processor 260 then demodulates, deinterleaves, and decodes each detected symbol stream to recover the traffic data for the data stream. The processing by RX data processor 260 is complementary to that performed by TX MIMO processor 220 and TX data processor 214 at transmitter system 210.

A processor 270 periodically determines which pre-coding matrix to use (discussed below). Processor 270 formulates a reverse link message comprising a matrix index portion and a rank value portion.

The reverse link message may comprise various types of information regarding the communication link and/or the received data stream. The reverse link message is then processed by a TX data processor 238, which also receives traffic data for a number of data streams from a data source 236, modulated by a modulator 280, conditioned by transmitters 254a through 254r, and transmitted back to transmitter system 210.

At transmitter system 210, the modulated signals from receiver system 250 are received by antennas 224, conditioned by receivers 222, demodulated by a demodulator 240, and processed by a RX data processor 242 to extract the reserve link message transmitted by the receiver system 250. Processor 230 then determines which pre-coding matrix to use for determining the beamforming weights then processes the extracted message.

In an aspect, logical channels are classified into Control Channels and Traffic Channels. Logical Control Channels comprises Broadcast Control Channel (BCCH) which is DL channel for broadcasting system control information. Paging Control Channel (PCCH) which is DL channel that transfers paging information. Multicast Control Channel (MCCH) which is Point-to-multipoint DL channel used for transmitting Multimedia Broadcast and Multicast Service (MBMS) scheduling and control information for one or several MTCHs. Generally, after establishing RRC connection this channel is only used by UEs that receive MBMS (Note: old MCCH+MSCH). Dedicated Control Channel (DCCH) is Point-to-point bi-directional channel that transmits dedicated control information and used by UEs having an RRC connection. In aspect, Logical Traffic Channels comprises a Dedicated Traffic Channel (DTCH) which is Point-to-point bi-directional channel, dedicated to one UE, for the transfer of user information. Also, a Multicast Traffic Channel (MTCH) for Point-to-multipoint DL channel for transmitting traffic data.

In an aspect, Transport Channels are classified into DL and UL. DL Transport Channels comprises a Broadcast Channel (BCH), Downlink Shared Data Channel (DL-SDCH) and a Paging Channel (PCH), the PCH for support of UE power saving (DRX cycle is indicated by the network to the UE), broadcasted over entire cell and mapped to PHY resources which can be used for other control/traffic channels. The UL Transport Channels comprises a Random Access Channel (RACH), a Request Channel (REQCH), an Uplink Shared Data Channel (UL-SDCH) and plurality of PHY channels. The PHY channels comprise a set of DL channels and UL channels.

The DL PHY channels may comprise:
Common Pilot Channel (CPICH)
Synchronization Channel (SCH)
Common Control Channel (CCCH)
Shared DL Control Channel (SDCCH)
Multicast Control Channel (MCCH)
Shared UL Assignment Channel (SUACH)
Acknowledgement Channel (ACKCH)
DL Physical Shared Data Channel (DL-PSDCH)
UL Power Control Channel (UPCCH)
Paging Indicator Channel (PICH)
Load Indicator Channel (LICH)
The UL PHY Channels may comprise:
Physical Random Access Channel (PRACH)
Channel Quality Indicator Channel (CQICH)
Acknowledgement Channel (ACKCH)
Antenna Subset Indicator Channel (ASICH)
Shared Request Channel (SREQCH)
UL Physical Shared Data Channel (UL-PSDCH)
Broadband Pilot Channel (BPICH)

In an aspect, a channel structure is provided that preserves low PAR (at any given time, the channel is contiguous or uniformly spaced in frequency) properties of a single carrier waveform.

For the purposes of the present document, the following abbreviations apply:
AM Acknowledged Mode
AMD Acknowledged Mode Data
ARQ Automatic Repeat Request
BCCH Broadcast Control Channel
BCH Broadcast Channel
C- Control-
CCCH Common Control Channel
CCH Control Channel
CCTrCH Coded Composite Transport Channel
CP Cyclic Prefix
CRC Cyclic Redundancy Check
CTCH Common Traffic Channel
DCCH Dedicated Control Channel
DCH Dedicated Channel
DL DownLink
DSCH Downlink Shared Channel
DTCH Dedicated Traffic Channel
FACH Forward link Access Channel
FDD Frequency Division Duplex
L1 Layer 1 (physical layer)
L2 Layer 2 (data link layer)
L3 Layer 3 (network layer)
LI Length Indicator
LSB Least Significant Bit
MAC Medium Access Control
MBMS Multimedia Broadcast Multicast Service
MCCHMBMS point-to-multipoint Control Channel
MRW Move Receiving Window
MSB Most Significant Bit
MSCH MBMS point-to-multipoint Scheduling Channel
MTCH MBMS point-to-multipoint Traffic Channel
PCCH Paging Control Channel
PCH Paging CHannel
PDU Protocol Data Unit
PHY PHYsical layer
PhyCHPhysical Channels
RACH Random Access Channel
RLC Radio Link Control
RRC Radio Resource Control
SAP Service Access Point
SDU Service Data Unit
SHCCH Shared channel Control Channel
SN Sequence Number
SUFI SUper FIeld
TCH Traffic Channel
TDD Time Division Duplex
TFI Transport Format Indicator
TM Transparent Mode
TMD Transparent Mode Data
TTI Transmission Time Interval
U- User-
UE User Equipment
UL UpLink
UM Unacknowledged Mode
UMD Unacknowledged Mode Data
UMTS Universal Mobile Telecommunications System
UTRA UMTS Terrestrial Radio Access
UTRAN UMTS Terrestrial Radio Access Network
MBSFN multicast broadcast single frequency network
MCE MBMS coordinating entity
MCH multicast channel
DL-SCH downlink shared channel
MSCH MBMS control channel
PDCCH physical downlink control channel
PDSCH physical downlink shared channel

FIG. 9 illustrates a wireless communication system 300, configured to support a number of users, in which the teachings herein may be implemented. The system 300 provides communication for multiple cells 302, such as, for example, macro cells 302A-302G, with each cell being serviced by a corresponding access node 304 (e.g., access nodes 304A-304G). In some aspects, macro cells 302A-302G may be the same as or similar to network device 12 and/or base station 16 (FIG. 1). As shown in FIG. 9, access terminals 306 (e.g., access terminals 306A-306L) may be dispersed at various locations throughout the system over time, wherein each access terminal 306 may be the same as or similar to UEs 14 (FIG. 1). Each access terminal 306 may communicate with one or more access nodes 304 on a forward link (“FL”) and/or a reverse link (“RL) at a given moment, depending upon whether the access terminal 306 is active and whether it is in soft handoff, for example. The wireless communication system 300 may provide service over a large geographic region. For example, macro cells 302A-302G may cover a few blocks in a neighborhood.

FIG. 10 illustrates a communication system 400 where one or more femto nodes are deployed within a network environment. Specifically, the system 400 includes multiple femto nodes 410 (e.g., femto nodes or HNB 410A and 410B) installed in a relatively small scale network environment (e.g., in one or more user residences 430), wherein the femto nodes 410 may be the same as or similar to network device 12 (FIG. 1). Each femto node 410 may be coupled to a wide area network 440 (e.g., the Internet) and a mobile operator core network 450 via a DSL router, a cable modem, a wireless link, or other connectivity means (not shown). As will be discussed below, each femto node 410 may be configured to serve associated access terminals 420 (e.g., access terminal 420A) and, optionally, alien access terminals 420 (e.g., access terminal 420B). In other words, access to femto nodes 410 may be restricted whereby a given access terminal 420 may be served by a set of designated (e.g., home) femto node(s) 410 but may not be served by any non-designated femto nodes 410 (e.g., a neighbor's femto node 410). Further, femto nodes 410 may each include a location determination component 30 configured to at least obtain femto node location information from one or more access terminals 420.

FIG. 11 illustrates an example of a coverage map 500 where several tracking areas 502 (or routing areas or location areas) are defined, each of which includes several macro coverage areas 504. Here, areas of coverage associated with tracking areas 502A, 502B, and 502C are delineated by the wide lines and the macro coverage areas 504 are represented by the hexagons. The tracking areas 502 also include femto coverage areas 506, which may include one or more coverage areas provided by network device 12 (FIG. 1). In this example, each of the femto coverage areas 506 (e.g., femto coverage area 506C) is depicted within a macro coverage area 504 (e.g., macro coverage area 504B). It should be appreciated, however, that a femto coverage area 506 may not lie entirely within a macro coverage area 504. In practice, a large number of femto coverage areas 506 may be defined with a given tracking area 502 or macro coverage area 504. Also, one or more pico coverage areas (not shown) may be defined within a given tracking area 502 or macro coverage area 504.

Referring again to FIG. 10, the owner of a femto node 410 and/or network device 12 (FIG. 1) may subscribe to mobile service, such as, for example, 3G mobile service, offered through the mobile operator core network 450. In addition, an access terminal 420 may be capable of operating both in macro environments and in smaller scale (e.g., residential) network environments. In other words, depending on the current location of the access terminal 420, the access terminal 420 may be served by an access node 460 of the macro cell mobile network 450 or by any one of a set of femto nodes 410 (e.g., the femto nodes 410A and 410B that reside within a corresponding user residence 430). For example, when a subscriber is outside his home, he is served by a standard macro access node (e.g., node 460) and when the subscriber is at home, he is served by a femto node (e.g., node 410A). Here, it should be appreciated that a femto node 420 may be backward compatible with existing access terminals 420.

A femto node 410 may be deployed on a single frequency or, in the alternative, on multiple frequencies. Depending on the particular configuration, the single frequency or one or more of the multiple frequencies may overlap with one or more frequencies used by a macro node (e.g., node 460). In some aspects, an access terminal 420 may be configured to connect to a preferred femto node (e.g., the home femto node of the access terminal 420) whenever such connectivity is possible. For example, whenever the access terminal 420 is within the user's residence 430, it may be desired that the access terminal 420 communicate only with the home femto node 410.

In some aspects, if the access terminal 420 operates within the macro cellular network 450 but is not residing on its most preferred network (e.g., as defined in a preferred roaming list), the access terminal 420 may continue to search for the most preferred network (e.g., the preferred femto node 410) using a Better System Reselection (“BSR”), which may involve a periodic scanning of available systems to determine whether better systems are currently available, and subsequent efforts to associate with such preferred systems. With the acquisition entry, the access terminal 420 may limit the search for specific band and channel. For example, the search for the most preferred system may be repeated periodically. Upon discovery of a preferred femto node 410, the access terminal 420 selects the femto node 410 for camping within its coverage area.

A femto node may be restricted in some aspects. For example, a given femto node may only provide certain services to certain access terminals. In deployments with so-called restricted (or closed) association, a given access terminal may only be served by the macro cell mobile network and a defined set of femto nodes (e.g., the femto nodes 410 that reside within the corresponding user residence 430). In some implementations, a node may be restricted to not provide, for at least one node, at least one of: signaling, data access, registration, paging, or service.

In some aspects, a restricted femto node (which may also be referred to as a Closed Subscriber Group Home NodeB) is one that provides service to a restricted provisioned set of access terminals. This set may be temporarily or permanently extended as necessary. In some aspects, a Closed Subscriber Group (“CSG”) may be defined as the set of access nodes (e.g., femto nodes) that share a common access control list of access terminals. A channel on which all femto nodes (or all restricted femto nodes) in a region operate may be referred to as a femto channel.

Various relationships may thus exist between a given femto node and a given access terminal. For example, from the perspective of an access terminal, an open femto node may refer to a femto node with no restricted association. A restricted femto node may refer to a femto node that is restricted in some manner (e.g., restricted for association and/or registration). A home femto node may refer to a femto node on which the access terminal is authorized to access and operate on. A guest femto node may refer to a femto node on which an access terminal is temporarily authorized to access or operate on. An alien femto node may refer to a femto node on which the access terminal is not authorized to access or operate on, except for perhaps emergency situations (e.g., 911 calls).

From a restricted femto node perspective, a home access terminal may refer to an access terminal that authorized to access the restricted femto node. A guest access terminal may refer to an access terminal with temporary access to the restricted femto node. An alien access terminal may refer to an access terminal that does not have permission to access the restricted femto node, except for perhaps emergency situations, for example, such as 911 calls (e.g., an access terminal that does not have the credentials or permission to register with the restricted femto node).

For convenience, the disclosure herein describes various functionality in the context of a femto node. It should be appreciated, however, that a pico node may provide the same or similar functionality for a larger coverage area. For example, a pico node may be restricted, and a home pico node may be defined for a given access terminal, and so on.

A wireless multiple-access communication system may simultaneously support communication for multiple wireless access terminals. As mentioned above, each terminal may communicate with one or more base stations via transmissions on the forward and reverse links. The forward link (or downlink) refers to the communication link from the base stations to the terminals, and the reverse link (or uplink) refers to the communication link from the terminals to the base stations. This communication link may be established via a single-in-single-out system, a multiple-in-multiple-out (“MIMO”) system, or some other type of system.

It is understood that the specific order or hierarchy of steps in the processes disclosed is an example of exemplary approaches. Based upon design preferences, it is understood that the specific order or hierarchy of steps in the processes may be rearranged while remaining within the scope of the present disclosure. The accompanying method claims present elements of the various steps in a sample order, and are not meant to be limited to the specific order or hierarchy presented.

Those of skill in the art would understand that information and signals may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof.

Those of skill would further appreciate that the various illustrative logical blocks, modules, circuits, and algorithm steps described in connection with the embodiments disclosed herein may be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present disclosure.

The various illustrative logical blocks, modules, and circuits described in connection with the embodiments disclosed herein may be implemented or performed with a general purpose processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general purpose processor may be a microprocessor, but in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration.

The steps of a method or algorithm described in connection with the embodiments disclosed herein may be embodied directly in hardware, in a software module executed by a processor, or in a combination of the two. A software module may reside in RAM memory, flash memory, ROM memory, EPROM memory, EEPROM memory, registers, hard disk, a removable disk, a CD-ROM, or any other form of storage medium known in the art. An exemplary storage medium is coupled to the processor such the processor can read information from, and write information to, the storage medium. In the alternative, the storage medium may be integral to the processor. The processor and the storage medium may reside in an ASIC. The ASIC may reside in a user terminal In the alternative, the processor and the storage medium may reside as discrete components in a user terminal.

The previous description of the disclosed embodiments is provided to enable any person skilled in the art to make or use the present disclosure. Various modifications to these embodiments will be readily apparent to those skilled in the art, and the generic principles defined herein may be applied to other embodiments without departing from the spirit or scope of the disclosure. Thus, the present disclosure is not intended to be limited to the embodiments shown herein but is to be accorded the widest scope consistent with the principles and novel features disclosed herein.

What is claimed is:

1. A method for location determination at a network device, comprising:
determining whether a first time value exceeds a repositioning time threshold value;
transmitting at least one instruction message to one or more mobile devices in response to determining that the first time value exceeds the repositioning time threshold value, wherein the at least one instruction message instructs the one or more mobile devices to report a mobile device location;
receiving at least one mobile device location message from each of the one or more mobile devices as a result of the transmitting; and
computing a network device location estimate based at least in part on the at least one mobile device location message.

2. The method of claim 1, further comprising:
determining whether the network device can receive an orbital object signal; and
wherein the transmitting, the receiving, and the computing are based on determining that the network device cannot receive the orbital object signal.

3. The method of claim 2, further comprising storing a located time value at which the network device location estimate is computed.

4. The method of claim 3, further comprising repeating the transmitting, the receiving, and the computing at a subsequent time where a time difference between the subsequent time and the located time value is greater than the repositioning time threshold value.

5. The method of claim 2, wherein determining whether the first time value exceeds the repositioning time threshold value comprises comparing the first time value to the repositioning time threshold value and wherein determining whether the network device can receive the orbital object signal occurs when the first time value is greater than the repositioning time threshold value.

6. The method of claim 1, wherein the at least one mobile device location message comprises information corresponding to the one or more mobile devices, wherein the information comprises at least one of a mobile device location, a mobile ID, a timestamp, a orbital object signal signal-to-noise ratio, orbital object availability, and a signal-to-noise ratio of a Bluetooth or WiFi signal, and further comprising storing the information in a mobile device database.

7. The method of claim 6, wherein computing the network device location estimate further comprises:
determining a group of strongest mobile devices based on one or more signal-to-noise ratios; and
assigning a new network device location estimate value based on the mobile device location associated with a mobile device from the group of strongest mobile devices that has a lowest orbital object signal signal-to-noise ratio.

8. The method of claim 7, wherein computing the network device location estimate further comprises:
determining whether an old network device location estimate value exists; and
setting the network device location estimate to the new network device location estimate value where the old network device location estimate value does not exist.

9. The method of claim 8, where the old network device location estimate value exists, further comprising:
comparing the old network device location estimate value to the new network device location estimate value to obtain a location difference value; and
comparing the location difference value to a location difference threshold value.

10. The method of claim 9, further comprising setting the network device location estimate to the new network device location estimate value where the location difference value is greater than the location difference threshold value.

11. The method of claim 9, further comprising, where the location difference value is greater than the location difference threshold value:
computing a midpoint between the old network device location estimate value and the new network device location estimate value to determine a midpoint network device location estimate value; and
setting the network device location estimate to the midpoint network device location estimate value.

12. An apparatus for location determination at a network device, comprising:
means for determining whether a first time value exceeds a repositioning time threshold value;
means for transmitting at least one instruction message to one or more mobile devices in response to determining that the first time value exceeds the repositioning time threshold value, wherein the at least one instruction message instructs the one or more mobile devices to report a mobile device location;
means for receiving at least one mobile device location message from each of the one or more mobile devices as a result of the transmitting; and
means for computing a network device location estimate based at least in part on the at least one mobile device location message.

13. The apparatus of claim 12, wherein the means for determining whether the first time value exceeds the repositioning time threshold value comprises means for comparing the first time value to the repositioning time threshold value and wherein the means for determining whether the network device can receive the orbital object signal executes when the first time value is greater than the repositioning time threshold value.

14. The apparatus of claim 12, wherein the means for computing the network device location estimate further comprises:
means for determining a group of strongest mobile devices based on one or more signal-to-noise ratios; and
means for assigning a new network device location estimate value based on a mobile device location of a mobile device from the group of strongest mobile devices that has a lowest orbital object signal signal-to-noise ratio.

15. The apparatus of claim 14, wherein the means for computing the network device location estimate further comprises:
means for determining whether an old network device location estimate value exists; and
means for setting the network device location estimate to the new network device location estimate value where the old network device location estimate value does not exist.

16. The apparatus of claim 15, where the old network device location estimate value exists, further comprising:
means for comparing the old network device location estimate value to the new network device location estimate value to obtain a location difference value; and
means for comparing the location difference value to a location difference threshold value.

17. The apparatus of claim 16, further comprising means for setting the network device location estimate to the new network device location estimate value where the location difference value is greater than the location difference threshold value.

18. The apparatus of claim 16, where the location difference value is greater than the location difference threshold value, further comprising:
means for computing a midpoint between the old network device location estimate value and the new network device location estimate value to determine a midpoint network device location estimate value; and
means for setting the network device location estimate to the midpoint network device location estimate value.

19. A computer program product for location determination at a network device, comprising:
a computer-readable medium comprising:
at least one instruction for determining whether a first time value exceeds a repositioning time threshold value;
at least one instruction for transmitting at least one instruction message to one or more mobile devices in response to determining that the first time value exceeds the repositioning time threshold value, wherein the at least one instruction message instructs the one or more mobile devices to report a mobile device location;
at least one instruction for receiving at least one mobile device location message from each of the one or more mobile devices as a result of the transmitting; and
at least one instruction for computing a network device location estimate based at least in part on the at least one mobile device location message.

20. The computer program product of claim 19, wherein the at least one instruction for determining whether the first time value exceeds the repositioning time threshold value comprises at least one instruction for comparing the first time value to the repositioning time threshold value and wherein the at least one instruction for determining whether the network device can receive the orbital object signal executes when the first time value is greater than the repositioning time threshold value.

21. The computer program product of claim 19, wherein the at least one instruction for computing the network device location estimate further comprises:
at least one instruction for determining a group of strongest mobile devices based on one or more signal-to-noise ratios; and
at least one instruction for assigning a new network device location estimate value based on the mobile device location of a mobile device from the group of strongest mobile devices that has a lowest orbital object signal signal-to-noise ratio.

22. The computer program product of claim 21, wherein the at least one instruction for computing the network device location estimate further comprises:
at least one instruction for determining whether an old network device location estimate value exists; and
at least one instruction for setting the network device location estimate to the new network device location estimate value where the old network device location estimate value does not exist.

23. The computer program product of claim 22, where the old network device location estimate value exists, further comprising:
at least one instruction for comparing the old network device location estimate value to the new network device location estimate value to obtain a location difference value; and
at least one instruction for comparing the location difference value to a location difference threshold value.

24. The computer program product of claim 23, further comprising at least one instruction for setting the network device location estimate to the new network device location estimate value where the location difference value is greater than the location difference threshold value.

25. The computer program product of claim 23, where the location difference value is greater than the location difference threshold value, further comprising:
at least one instruction for computing a midpoint between the old network device location estimate value and the new network device location estimate value to determine a midpoint network device location estimate value; and
at least one instruction for setting the network device location estimate to the midpoint network device location estimate value.

26. A network device apparatus for location determination, comprising:
a location determination component configured to determine whether a first time value exceeds a repositioning time threshold value;
a communication component configured to transmit at least one instruction message to one or more mobile devices in response to determining that the first time value exceeds the repositioning time threshold value, wherein the at least one instruction message instructs the one or more mobile devices to report a mobile device location;
wherein the communication component is further configured to receive at least one mobile device location message from each of the one or more mobile devices as a result of the transmitting; and
wherein the location component is further configured to compute a network device location estimate based at least in part on the at least one mobile device location message.

27. The apparatus of claim 26, further comprising an orbital object component configured to determine whether the network device can receive an orbital object signal, and wherein the communication component is configured to perform the transmitting and the receiving, and wherein the location determination component is configured to perform the computing, where the orbital object component determines that the network device cannot receive the orbital object signal.

28. The apparatus of claim 27, wherein the location determination component is further configured to store a located time value at which the network device location estimate is computed.

29. The apparatus of claim 28, further wherein the communication component is further configured to repeat the transmitting and the receiving, and wherein the location determination component is configured to repeat the computing, at a subsequent time where a time difference between the subsequent time and the located time value is greater than the repositioning time threshold value.

30. The apparatus of claim 27, wherein to determine whether the first time value exceeds the repositioning time threshold value, the location determination component is further configured to compare the first time value to the repositioning time threshold value and wherein the orbital object component is further configured to determine whether the network device can receive the orbital object signal when the first time value is greater than the repositioning time threshold value.

31. The apparatus of claim 26, wherein the at least one mobile device location message comprises information corresponding to the one or more mobile devices, wherein the information comprises at least one of a mobile device location, a mobile ID, a timestamp, an orbital object signal signal-to-noise ratio, orbital object availability, and a signal-to-noise ratio of a Bluetooth or WiFi signal, and wherein the location determination component is further configured to store the information in a mobile device database.

32. The apparatus of claim 31, wherein to compute the network device location estimate, the location determination component is further configured to:
determine a group of strongest mobile devices based on one or more signal-to-noise ratios; and
assign a new network device location estimate value based on the mobile device location of a mobile device from the group of strongest mobile devices that has a lowest orbital object signal signal-to-noise ratio.

33. The apparatus of claim 32, wherein to compute the network device location estimate, the location determination component is further configured to:
determine whether an old network device location estimate value exists; and
set the network device location estimate to the new network device location estimate value where the old network device location estimate value does not exist.

34. The apparatus of claim 33, where the old network device location estimate value exists, the location determination component is further configured to:
compare the old network device location estimate value to the new network device location estimate value to obtain a location difference value; and
compare the location difference value to a location difference threshold value.

35. The apparatus of claim 34, wherein the location determination component is further configured to set the network device location estimate to the new network device location estimate value where the location difference value is greater than the location difference threshold value.

36. The apparatus of claim 34, where the location difference value is greater than the location difference threshold value, the location determination component is further configured to:
compute a midpoint between the old network device location estimate value and the new network device location estimate value to determine a midpoint network device location estimate value; and
set the network device location estimate to the midpoint network device location estimate value.
